(19) United States
(12) Patent Application Publication
(10) Pub. No.: US 2022/0206540 A1
(43) Pub. Date: Jun. 30, 2022

(54) PORTABLE SEALED HOUSING FOR TABLETS, ELECTRONIC SENSORS AND LINKED PORTS

(71) Applicant: SAMMIC, S.L., Azkoitia (ES)

(72) Inventors: Chao CHEN, Azkoitia (ES); Jon Joseba MARQUINA IRIARTE, Azkoitia (ES); Gorka AGIRREZABAL OTEIZA, Azkoitia (ES)

(21) Appl. No.: 17/477,954

(22) Filed: Sep. 17, 2021

(30) Foreign Application Priority Data
Dec. 29, 2020 (ES) 202032803

(51) Int. Cl. G06F 1/16; H04B 1/3888

(52) U.S. Cl. CPC G06F 1/1656; H04B 1/3888; G06F 1/1626

(57) ABSTRACT

A portable sealed housing for tablets, electronic sensors and linked ports includes a front cover with viewing window corresponding to the tablet screen, a rear cover removable attached to the front cover and having geometry corresponding to the front cover. There is a binder prominence, from the centre of the rear cover to its lower end, capable of housing at least three contiguous electronic sensors orienting their readers (LF and HF reader, UHF reader and QR code reader) towards the unitary reader window existing in the centre of the lower face of the binder prominence and the front cover. There is a port centralizing slot capable of physical connection with at least three port, printer connection, power supply of the tablet and scale connection.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This invention relates to a portable sealed housing. More specifically, it refers to a portable sealed housing for tablets, electronic sensors and linked ports for use in the field of digitalised or 4.0 professional kitchens and structured on the basis of a front cover with a viewing window corresponding to the screen of a tablet housing a tablet and detachably attached to a rear cover with a geometry corresponding to the front cover and in which the different electronic sensors are housed that allow the correct operation of the tablet.

### 2. Description of Related Art Including Information Disclosed Under 37 CFR 1.97 and 37 CFR 1.98

In the field of digitalised or 4.0 professional kitchens, a central computer or Track is currently used that serves not only as a display element to the user through its display or tablet, but also serves as an operations or process instructor to the different machines that are part of the cooking or regeneration process, such as cookers, blast chillers, packers, regenerators, etc. The use of these electronic devices is due to the need to achieve good traceability, food safety and automation in culinary processes such as cooking or regeneration, and in particular it is also necessary in order to comply with the HACCP system (Hazard Analysis and Critical Control Points) which is a system in which food safety is addressed through the identification, analysis and control of physical, chemical and biological hazards of raw materials and the stages of the manufacturing process and even distribution and consumption of the finished product. These process control systems also require knowing the identity of the specific kitchen operator who has been responsible for that cooking or regeneration process.

Thus, this Track or central computer receives instructions and data from the food parcels or rations through different channels, through reprogrammable smart tags that include RFID codes of different kinds and read by different systems with different types of sensors; LF (Low Frequency), HF (High Frequency), UHF (Ultra High Frequency) and through programmable smart labels such as; labels or chips linked to the food package, QR codes or barcodes (not reprogram mable) that are attached by an adhesive to the food package and/or identification bracelets that also include an LF-type RFID chip and that the kitchen operator wears on the wrist to identify his identity and who is responsible for the process, the work day, etc. Each of these remote data storage and retrieval systems uses different readers to decode the information contained in them, such as LF (Low Frequency) band readers, HF (High Frequency) reader and UHF (Ultra High Frequency) reader or QR code reader.

Until now, these different readers were incorporated into the Track without being unified or centralized, nor were they adequately protected. Likewise, it occurred when linking this central computer or Track, by means of a wired connection, to the ports of the peripherals used, for example; printing machines, weighing scales, associated video cameras and even for powering the tablet, etc., which meant having a central computer or non-portable track and exposing its sensors, ports and cables to the risks of a kitchen. This arrangement, in addition to not protecting the essential control elements of this tracking system for professional kitchens, forced the user to recognize which reader to use depending on the coding system used on each label, each sensor being located at a different point around the electronic tablet and also to find the correct port around the tablet for the correct connection selected.

Therefore, by generating a centralization of the possibility of communication of the system, by means of a portable sealed housing in which all the readers and all possible ports of the central computer, Track or tablet are centralized is essential to protect all the elements that are in the system and avoid confusion and unnecessary operations to search for the specific reader and port to use, as well as to ensure its portability and protection.

In the current state of the art, tablets or central Tracks are known that allow for the manual introduction or by reading of chips or other communication codes, the different variables involved in the cooking process, such as; raw material and its reception date, temperature, cooking time, recipes, preparation instructions, etc., its readers being at the bottom of the Tablet screen and under it and on its sides. Thus, in known tracking systems, there is no single reading area, which causes confusion for the user who does not know the location of the reader associated with that specific label or code, increasing the time until the correct reading and therefore the cooking process.

Likewise, both the wiring associated with the ports and the sensors of these Tracks are visible on the outside, damaging the aesthetics and what is more important, compromising the safety of the whole, since because in kitchen environments it is common to find work environments with high temperature vapours, liquid splashes, food residues, etc., which when in contact with the wiring and sensors can seriously damage the Track and its peripheries, increasing repair costs and maintenance times. Likewise, the exposure of the wiring and electronic sensors to the outside makes the set's portability difficult, and it could be damaged during transport. For this reason, it is essential to have a portable sealed housing that covers the shortcomings of currently-known tablet tracking systems, allowing portability, facilitating traceability, guaranteeing the safety of the set and reducing time in culinary processes.

### BRIEF SUMMARY OF THE INVENTION

Compared to the state of the art previously described, the present invention has as its object a portable sealed housing for tablets, electronic sensors and linked ports consisting of a front cover with a corresponding viewing window with a tablet screen capable of housing a tablet and linked removably to a rear cover with a corresponding geometry to the front cover consisting of; a binder prominence, from the centre of the rear cover to its lower end, capable of housing at least three contiguous electronic sensors orienting its readers; LF and HF reader, UHF reader and QR code reader towards the existing unitary reader window in the centre of the lower face of the binder prominence and the front cover, and a port centralizing slot capable of physical connection with at least three ports; connection to the printer, power to the tablet and connection to scale.

Thanks to this configuration, the present invention is equipped with ergonomics by being located in a single unitary reading window of all the readers, and located in the lower part of the viewing window and in particular on the underside of the binder prominence. Thus, it is not necessary to raise the food package excessively, nor the identification bracelet, to read its identification code, since the location of the unitary reading window is on the underside of the binder prominence. In addition, the reading of these different coding systems: QR codes; reprogrammable chips or identification bracelets are located in the same place, so the gesture of the kitchen operator is always the same and therefore the automation of the actions by the user is facilitated. On the other hand, by means of the arrangement of this binder prominence, it is possible to direct the readers of the different electronic sensors incorporated to a single reading point, the one selected, in the lower central part, being the most optimal for use.

Additionally, with the present invention, a reduction in food preparation times is obtained, since, as the electronic sensors are inside the portable sealed housing and all its readers are oriented towards the same unit reading window, the possible error in the recognition of the correct reader is reduced to zero. Therefore, the user will always hit the mark and read the correct code by bringing the code or chip closer to the lower area of the unitary reader window and to the different readers acting at the same reading point, being able to read the different coding systems used. In addition, as usual, the QR code reader incorporates an LED warning light with a laser light for reading, so the operator will have the reference of this light to confirm that it is in the correct reading place, that is, with the light the correct reading position by the user is assured, and since the rest of the sensors or readers are contiguous, they can also read any other data storage system by placing the code or chip under that LED that is radiated under the unitary reader window.

This configuration of the portable sealed housing with a central binder prominence allows a surface to be generated on its lower face where, in addition to the unitary reader window, useful peripherals for the Tablet such as an additional video camera or the lens of a camera built into the tablet can be housed. The fact that it is removable, using common joining elements such as; screws, pins, elastic hooks, etc., allows the replacement and easy repair of the damaged element in each case, instead of the replacement of all the components, assuming this a reduction in maintenance times and costs.

Likewise, thanks to the configuration of the present invention, the protection of internal devices is increased; Tablet, electronic devices and ports, since these are sensitive to external agents such as humidity being in environments with high humidity, being environments that use the sous-vide or vacuum cooking system, in which the vapours are at high temperature and they are detrimental to the electronic internals. Additionally, the internal elements are protected from food waste such as small pieces of food, fats, sauces, liquids, or other types of dirt harmful to them.

Due to the fact that in the field of professional kitchens we work with a high multiplicity of simultaneous commands, kitchen processes must be as automated as possible, so agility, speed and effectiveness are essential for both process optimization and to reduce cooking times. Thanks to the prominence configuration, a receptacle of perfect dimension, configuration and geometry is generated to house the electronic sensors and orient its readers (LF, HF, UHF or QR) to the right place for the correct reading and identification of the food package under the unitary reading window. On the other hand, the fact that the protrusion is central allows an easy grasp and reading of the viewing window and determines that the ends of the portable sealed housing have a sufficiently reduced thickness so that the user can grasp it from the sides without the use of a support bracket and facilitating its transport. Although this portable sealed housing allows the easy addition of additional lugs or grips of softer materials, such as silicone, for a more comfortable manual grip by the user if necessary.

Another advantageous feature of the present invention is that the binder prominence has a perimeter fin. This flap will allow a greater protection of the unitary reader window and the centralizing port slot since therewith the areas sensitive to the introduction of waste or receiving knocks are covered. Furthermore, the configuration with a protrusion generates a joint platform with a larger area to the rear of the protrusion, which is an advantage since it can incorporate a clamping plate or any other support.

Thanks to this elevation configuration of the binder prominence and horizontal generation of the platform, a surface is established in which the clamping hook can be incorporated that guarantees the mooring of the portable sealed housing to a wall, shelf, or allows a support on a surface, favouring its versatility of location and mode of use.

Another additional advantage is that a reader window stop is provided between the lower vertex of the connecting platform and the unitary reader window. Thanks to the reading window stop, the reading point can be deeply limited and allows the user to correctly insert the identification tag, without it being inserted into an excessively deep area, which would result in an incorrect identification thereof.

In the front cover of the housing, there is a camera window corresponding to the camera of the tablet. In this manner, easy access to tablet accessories such as a camera is allowed, giving the present invention greater versatility.

Additionally, it is envisaged that in the portable sealed housing there be an elastic membrane corresponding to the power button of the tablet. This allows the activation of the Tablet directly through an elastic silicone membrane or any other elastic material allowing pressure on it to activate the on or off button of the Tablet.

Lastly, the present invention provides that at the sides of the unitary reading window and close to the front vertex of the front cover there be at least two indicating protrusions. With these indicator protrusions, which are visible by the kitchen user when standing in front of the portable sealed casing, the orientation of the place of insertion of the identification tags or bracelets is facilitated for reading, and with this the user knows the correct situation of the reading unitary reader window. Furthermore, this protrusion is envisaged to have a different colour than the portable sealed housing to facilitate its differentiation and rapid visualization. The housing material will be made of a highly durable and fire-retardant material, such as polyamide or another technical material resistant to degradation with common kitchen grease.

### BRIEF DESCRIPTION OF THE SEVERAL VIEWS OF THE DRAWINGS

In order to better understand the nature of the invention, an arrangement is presented in the attached drawings which is merely illustrative and non-limiting.

FIG. 1 represents an exploded view in perspective and seen from the lower face of the portable sealed housing (1) and it shows the front cover (1a) of a dimension corresponding to the rear cover (1b) and housing the tablet (7). On the rear cover (1b) you can see the binder prominence (2) that will house the electronic sensors (3) that will be contiguous and orienting their readers (3a, 3b and 3c) towards the only existing unitary reader window (2b) between the centre of the lower face (2a) of the binder prominence (2) and the front cover (1a). In addition, between the lower vertex of the connection platform (2d) and the unitary reader window (2b), the existence of the reader window stop (2b.1) is foreseen, which will prevent the excessively deep inclusion of the identification cards, codes and bracelets for a correct reading thereof, and on the sides of the unitary reader window (2b), the existence of indicator protrusions (10) that will be visible facing the portable sealed housing (1). Finally, the cables (4a, 4b and 4c) are observed which will be connected to the ports (4) for the connection of the scale, printer or others, as well as to supply current to the tablet (7).

FIG. 2 represents an exploded perspective view with a side view of the portable sealed housing (1) in which the centralizing port slot (2c) in which the ports (4) will be housed is observed. In addition, the perimeter fin (2e) that has the binder prominence (2) is observed together with the joining platform (2d) in which the incorporation of the fastening plate (8) is foreseen. On the other hand, the tablet (7) that will be housed between the rear cover (1b) and the front cover (1a) which contains the camera window (5) and the viewing window (9) is observed.

FIG. 3 represents the perspective view of the lower part of the assembled portable sealed housing (1) in which the flat lower face (2a) of the binder prominence (2) in which the electronic sensors (3) are housed is observed, allowing the reading through the unitary reader window (2b), the arrangement of the reader window stop (2b.1), in addition to the central arrangement of the unitary reader window (2b) between the front cover (1a) and the rear cover (1b) together with the indicator protrusions (10) and the provided additional camera or lens (11). The junction platform (2d) and the perimeter fin (2e) arranged in the binder prominence (2) can also be observed.

FIG. 4 represents a perspective view of the assembled portable sealed housing (1) in which the tablet (7) is housed between the rear cover (1b) and the front cover (1a) which presents the camera window (5) and the viewing window (9) and in which the elastic membrane (6) corresponding to the power button of the tablet (7) is arranged in its upper part. On the other hand, in the lower part of the portable sealed housing (1) the planned location of the additional camera or lens (11) is observed.

FIG. 5 represents a perspective view of the portable sealed housing (1) mounted in which on one of the sides the arrangement of the ports (4) is observed, being; the printer connection (4a), the power supply (4b) of the tablet (7) and the scale connection (4c), all of which are housed in the centralizing slot (2c) of the binder prominence (2) which contains the protective perimeter fin (2e) and the joining platform (2d) on which the clamping plate (8) is attached. Finally, the elastic membrane (6) corresponding to the power button of the tablet (7) (not represented) is observed. In these figures, the following references are indicated:

1. Portable sealed housing

1a. Front cover

1b. Rear cover

2. Binding prominence

2a. Lower face of the binder prominence (2)

2b. Unitary reader window

2b.1. Reader window stopper

2c. Port centralizer slot (4)

2d. Junction platform

2e. Perimeter flap

3. Electronic sensors

3a. LF (Low Frequency) and HF (High Frequency) reader

3b. UHF (Ultra High Frequency) reader

3c. QR code reader

4. Ports

4a. Printer connection

4b. Tablet power supply (7)

4c. Scale connection

5. Camera window

6. Elastic membrane

7. Tablet

7a. Tablet camera (7)

8. Holding plate

9. Viewing window

10. Indicator protuberance

11. Additional camera or lens

### DETAILED DESCRIPTION OF THE INVENTION

With regard to the above-listed drawings and references, a preferred embodiment of the object of the invention is illustrated in the attached drawings, referring to a portable sealed housing (1) for tablets (7), electronic sensors (3) and linked ports (4), which consist of a front cover (1a) with viewing window (9) corresponding to the tablet screen (7) capable of housing a tablet (7) and removably attached to a rear cover (1b) of geometry corresponding to the front cover (1a) consisting of; a binder prominence (2), from the centre of the rear cover (1b) to its lower end, capable of housing at least three contiguous electronic sensors (3) orienting their readers; LF and HF reader (3a), UHF reader (3b) and QR code reader (3c) towards the unitary reader window (2b) existing in the centre of the lower face (2a) of the binder prominence (2) and the front cover (1a), and a port centralizing slot (2c) capable of physical connection with at least three ports; printer connection (4a), power supply (4b) of the tablet (7) and scale connection (4c).

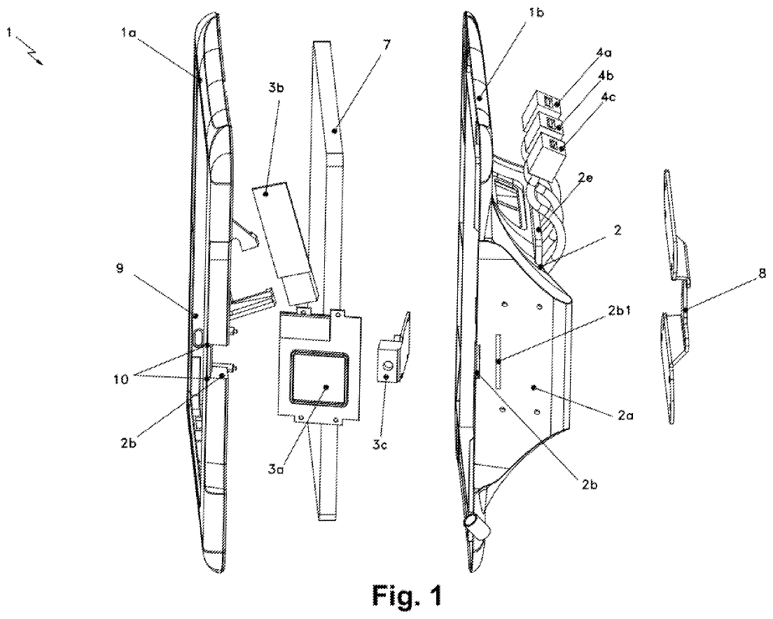

As can be seen in FIG. 1, with the housing (1) of the present invention, a single unitary reading window (2b) is located in the centre of the lower face (2a) of the binder prominence (2) and the front cover (1a), which gives this invention ergonomics and precision, not being necessary to lift or move excessively the food package with its identification code, nor the identification bracelet, to read the information of its code since the only reading point for all the codes and linked chips is found on the underside of the housing and guarantees a correct reading as there is a single reading window (2b) for communication with the tablet (7).

Thanks to the configuration of the prominence (2), a receptacle of perfect dimension and geometry is generated to house the electronic sensors (3) and orient their readers (3a, 3b and 3c) to the appropriate place for the correct reading and identification of the code or food package card. In addition, the gesture of the kitchen operator is always the same and therefore the automation of the actions by the user is facilitated, since the reading of these different coding systems: QR codes; reprogrammable chips or ID bracelets are located in the same place. Therefore, a single reading place is achieved in the lower part, this being the most optimal and guarantor of the well-being of the kitchen staff. Furthermore, by arranging this binder prominence (2) it is possible to direct the readers (3a, 3b and 3c) of the different electronic sensors (3) incorporated into a single communication window, the unitary reader window (2b), reducing to zero the possible error in the recognition of the correct reader (3a, 3b and 3c) and reducing the times in food preparation. Thus, the user will always succeed by bringing the code, chip or bracelet to the lower area of the unitary reader window (2b), guaranteeing that the readers (3a, 3b and 3c) are capable of reading any of the different coding systems used.

Additionally, the operator will have the reference of the QR reader light (3c) to confirm that it is in the correct reading place and thanks to the fact that the readers (3a, 3b and 3c) of the electronic sensors (3) are contiguous they will be able to read, under the unitary reader window (2b), any data storage system placing the code or chip. This configuration of the portable sealed housing (1) with a central binder prominence (2) allows a surface to be generated on its lower face (2a), where, in addition to the unitary reading window (2b), useful peripherals for the Tablet such as an additional video camera (11) or its lens, as well as any other small peripheral.

Another advantageous aspect of the configuration of the portable sealed housing (1) is that, as it is removable, it allows the replacement and easy repair of the damaged element in each case, instead of the replacement of all the components, this supposing a reduction in maintenance times. For the connection of the front cover (1a) and the rear cover (1b), usual connection elements are provided, such as; screws, pins, elastic hooks, etc. On the other hand, the depth reading point can be limited by allowing the user to correctly insert the identification tag, without it being inserted into an excessively deep area of the reading area, which would result in an incorrect identification thereof. This is due to the fact that between the lower vertex of the joining platform (2d) and the unitary reader window (2b) the existence of a reader window stop (2b.1) is foreseen.

Likewise, it is envisaged that on the sides of the unitary reading window (2b) and close to the front vertex of the front cover (1a) there will be at least two indicating protrusions (10) with a colour different from that of the portable sealed housing (1) to facilitate their differentiation. Thus, these indicator protrusions (10) will be visible by the kitchen user when facing the portable sealed housing (1), facilitating the orientation and determination of the place of introduction of the identifying labels for their reading, and thus the user will know the specific situation of the unitary reading window (2). It is envisaged that the QR code reader (3c), attached to the inside of the lower face (2) of the binder prominence (2a) of the portable sealed housing (1), will be positioned behind the LF and HF reader (3a) optimizing the reading under the unitary reading window (2b) and the reading extension of the readers (3a, 3b and 3c).

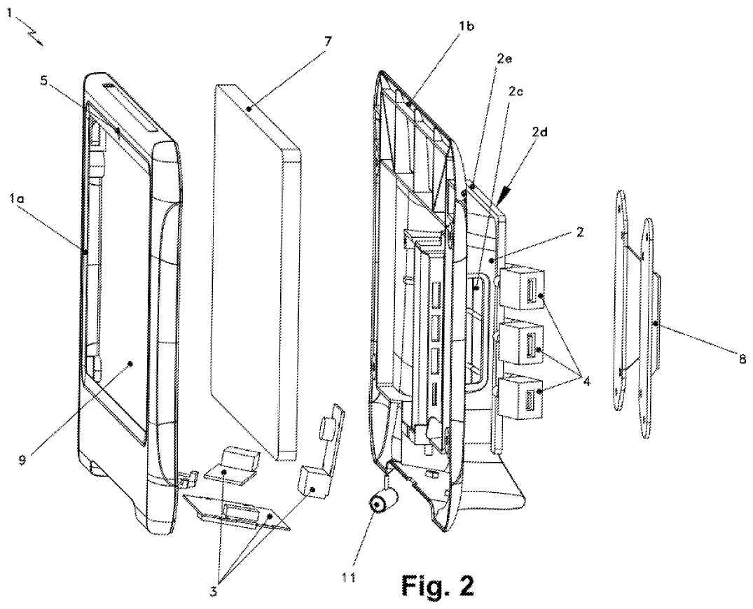

As can be seen in FIG. 2, an advantageous aspect of the present invention is that greater protection of the unitary reading window (2b) and the centralizing slot (2c) of ports (4) is allowed because the binding prominence (2) has a perimeter flap (2e) with which the areas sensitive to the introduction of debris or to receiving knocks are covered. On the other hand, it is observed that all the ports of precise electronic devices (4) are grouped in a centralizing slot (2c), which will eliminate times in the process of connecting peripherals to the tablet (7) since all the cables (4a, 4b and 4c) will be connected by the same lateral slot.

Thus, the portable sealed housing (1) of this invention manages to group all the essential elements for the operation of the tablet (7) as a process Track, being incorporated into it; tablet (7), electronic sensors (3) and ports (4) in a compact way and guaranteeing efficient operation and fast operability, as well as the portability of all the elements. In addition, this morphology allows for the generation of a joining platform (2d) with an area greater than the rear of the binder prominence (2), which allows a clamping plate (8) to be incorporated therein even greater than the binder prominence (2). Another advantageous technical characteristic that can be seen in FIG. 2 is that in order to easily access the accessories of the tablet (7), such as its camera, the existence of a camera window (5) corresponding to the tablet camera (7). This provides greater versatility to the portable sealed housing (1) of the present invention.

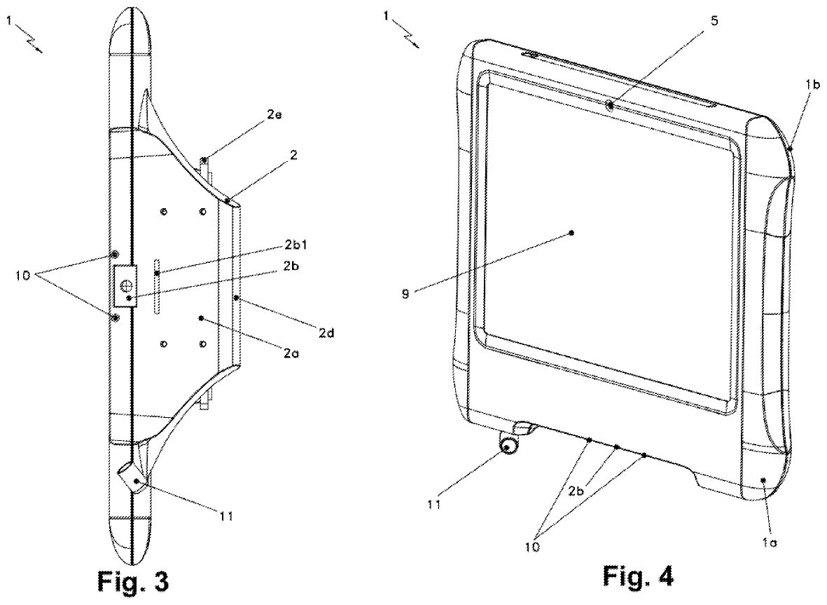

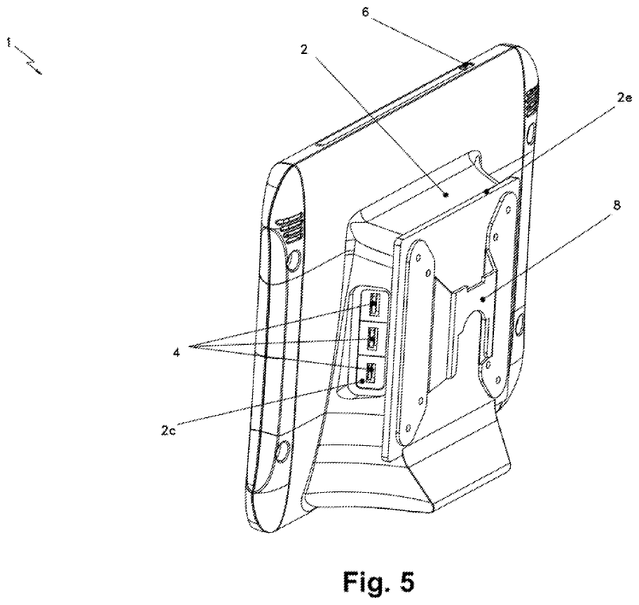

As can be seen in FIG. 3, in the centre of the lower face (2a) of the binder prominence (2) and the front cover (1a) the unitary reading window (2b) is located, favouring the ergonomics of the housing (1), since it allows the kitchen operator's gesture to read the identification code to always be the same, facilitating the reading task and its automation by the operator who will take any code used to the unitary reading window (2b), since all the readers (3a, 3b and 3c) are at the same reading point. Thanks to the generation of the surface on the lower face (2a) of the binder prominence (2), they can be accommodated; useful peripherals such as an additional video camera (11) or its lens, the camera being integrated and the reading window stop (2b.1) to limit the depth reading point allowing the user to correctly insert the identification tag.

Furthermore, as can be seen in FIG. 3, it is envisaged that on the sides of the unitary reader window (2b) and near the front vertex of the front cover (1a), there are at least two indicator protrusions (10) to facilitate the orientation of the place of introduction of the identifying labels for their reading. All these characteristics aimed at guaranteeing the well-being of the kitchen staff are important, since professional kitchens work with a high multiplicity of simultaneous commands, which means that the kitchen processes must be as automated as possible, and agility, speed and effectiveness are essential both for the optimization of processes and for the reduction of times.

As can be seen in FIG. 4, due to the morphology that the portable sealed housing (1) presents when it has all its elements incorporated and ready for use, the protection of the internal devices of the Track is increased (tablet (7), electronic sensors (3) and ports (4)). This advantageous technical aspect is essential, since these internal devices are sensitive to external agents such as humidity present in environments that use the sous-vide culinary system. As a consequence of this conformation, the internal elements are protected from food waste such as small pieces of food, fats, sauces, liquids, or other types of dirt harmful to them.

Another characteristic advantage of the present invention is that a flat surface is established with the joining platform (2d) in which the fastening plate (8) can be incorporated, which guarantees the mooring of the portable sealed housing (1) to a wall, shelf, or lean on a surface, favouring its versatility of location and mode of use and can also be used without clamping by means of the clamping plate (8) or similar, holding it by the sides as it is not too thick for manual grip and since its binder prominence (2) is central. In addition, for the direct operation of the tablet (7) it is foreseen that in the portable sealed housing (1) there is an elastic membrane (6), corresponding to the power button of the tablet (7), made of silicone or any other elastic material. Thus, pressure on it is allowed to activate the tablet's on or off button (7).

Lastly, this portable sealed housing (1) will allow the easy incorporation of additional lugs or handles made of softer materials, such as silicone for a more comfortable manual grip by the user, that is, the present invention is endowed with great portability in this configuration.

The essential nature of this invention is not altered by variations in materials, shape, size and arrangement of the component elements, described in a non-limiting manner, this being enough to proceed to its reproduction by an expert.

1. A portable sealed housing for tablets, electronic sensors and linked ports, comprising: a front cover with viewing window corresponding to the tablet screen capable of housing a tablet and attached removably to a rear cover with a geometry corresponding to the front cover; a binder prominence, from the centre of the rear cover to its lower end, capable of housing at least three contiguous electronic sensors, orienting its readers; LF and HF reader, UHF reader and QR code reader towards the unitary reader window existing in the centre of the lower face of the binder prominence and the front cover, and a port centralizing slot capable of physical connection with at least three ports; connection to the printer, power supply of the tablet and scale connection.

2. The portable sealed housing, according to claim 1, wherein the binder prominence has a perimeter fin.

3. The portable sealed housing, according to claim 1, wherein the binder prominence is comprised of a connecting platform in which the incorporation of a clamping plate is foreseen.

4. The portable sealed housing, according to claim 1, further comprising: a reading window stop between the lower vertex of the joining platform and the unitary reading window.

5. The portable sealed housing, according to claim 1, wherein the front cover provides for the existence of a camera window corresponding to the camera of the tablet.

6. The portable sealed housing, according to claim 1, wherein the removable sealed housing there is an elastic membrane corresponding to the power button of the tablet.

7. The portable sealed housing, according to claim 1, wherein, on the sides of the unitary reader window and close to the front vertex of the front cover the existence of at least two indicating protrusions is provided.
